(19) United States
(12) Patent Application Publication
(10) Pub. No.: US 2013/0074114 A1
(43) Pub. Date: Mar. 21, 2013

(54) DISPLAY METHOD AND OPERATION METHOD BASED ON VCHIP

(71) Applicants: Chao Liu, Qingdao City (CN); Mingang Wang, Qingdao City (CN); Fen Liu, Qingdao City (CN); Guangfeng Zhang, Qingdao City (CN); Tao Gao, Qingdao City (CN)

(72) Inventors: Chao Liu, Qingdao City (CN); Mingang Wang, Qingdao City (CN); Fen Liu, Qingdao City (CN); Guangfeng Zhang, Qingdao City (CN); Tao Gao, Qingdao City (CN)

(73) Assignees: QING DAO HAIER ELECTRONIC CO., LTD., Qingdao City, Shandong Province (CN); HAIER GROUP CO., LTD., Qingdao City, Shandong Province (CN)

(21) Appl. No.: 13/699,639

(22) PCT Filed: Dec. 3, 2010
(86) PCT No.: PCT/CN10/79434

§ 371 Date: Nov. 23, 2012

(51) Int. Cl. H04N 21/00

(52) U.S. Cl. 725/28

(57) ABSTRACT

A display method based on Vchip includes: displaying a plurality of first ratings in a first level menu; and displaying a plurality of second ratings corresponding to each of the first ratings in a second level menu. In one embodiment, the first ratings are program content ratings, and the second ratings are age ratings. In other embodiment, the first ratings are age ratings, and the second ratings are program content ratings. The program content rating and the corresponding age ratings are respectively displayed in two level menus; therefore, it is easy to be understood and does not make the users confused, and is more convenient for operation.

### TECHNICAL FIELD

This description relates to TV technologies, and more particularly relates to a display method of parents lock function and operation method thereof.

### DESCRIPTION OF BACKGROUND

In some countries, TV programs and movies are filled with erotic and violent scenes; these are very harmful for minors. In order to avoid the harm to minors from the erotic and violent content in the TV programs and movies, a rating system about the movies is required by Motion Pictures Association of America (MPAA). Specifically, the movies are classified into different ratings respectively for people of different ages to watch, according to the erotic and violent content. This rating system also extends to TV programs afterwards.

In order to ensure that the rating system can be applied in TV programs, and that the guardians of minors can effectively set blocking levels to prohibit the minors from watching certain TV programs, TV manufacturers generally use violence chips (Vchip) to achieve ratings lock.

Vchip function is an electronic lock function, used to help the parents block TV programs and movies which are erotic or violent and unsuitable for their children. Vchip uses Vertical Blanking Interval (VBI) of standard TV signals to contain a code indicating the one or more ratings coefficients of the programs to be displayed. The ratings coefficients comprise ratings similar to these announced by MPAA, such as G, PG, PG-13, R, NC-17 etc., and numerical ratings about program categories, such as violence, language, nudity or sexual content.

Vchip function is realized by storing a ratings standard of TV programs or movies in TV, and generally displaying the program content ratings and age ratings on the screen in a two-dimensional matrix. It is the user to set a certain blocking level for the TV programs or movies according to the corresponding ratings standards, in order to prevent the minors from watching violent programs or pornographies. However, in the TV with Vchip function, the ratings are displayed in a two-dimensional matrix, which is not intuitive to be understood and easily makes the users confused to operate.

### SUMMARY

The present embodiment is to provide a display method of parents lock function which is easy to be understood and does not make the users confused.

The present embodiment is to provide an operation method of parents lock function which is easy to be understood and convenient for operation.

To solve these technical problems, the present invention adopts the following solutions.

A display method of parents lock function includes: displaying a plurality of first ratings in a first level menu; and displaying a plurality of second ratings corresponding to the first ratings in a second level menu. In one embodiment, the first ratings are program content ratings, and the second ratings are age ratings. In other embodiment, the first ratings are age ratings, and the second ratings are program content ratings.

An operation method of parents lock function includes: displaying a first level menu, wherein the first level menu contains a plurality of first ratings; selecting one of the first rating in the first level menu; displaying a second level menu corresponding to the selected first rating, wherein the second level menu contains a plurality of second ratings; and modifying a locking status of the selected second rating. In one embodiment, the first ratings are program content ratings, and the second ratings are age ratings. In other embodiment, the first ratings are age ratings, and the second ratings are program content ratings.

Furthermore, the program content ratings comprises A, F, L, S, V and D, and wherein A represents ordinary TV programs, F represents TV programs having fantasy violence, L represents TV programs having strong coarse language, S represents TV programs having sex-related situation, V represents TV programs having violence, and D represents TV programs having strongly suggestive dialog.

Furthermore, the age ratings comprises TV-Y, TV-Y7, TV-G, TV-PG, TV-14, TV-MA and TV-None, and wherein TV-Y represents TV programs suitable for all ages of children; TV-Y7 represents TV programs suitable for children over 7 years of age; TV-G represents TV programs suitable for all audience; TV-PG represents TV programs not suitable for teenagers and children to watch or viewable for minors accompanied with guardian; TV-14 represents TV programs the general guardians do not want the children under the age of 14 to watch; TV-MA represents TV programs only suitable for adults and greatly unsuitable for minors under the age of 17 to watch; TV-None represents TV programs not required to be rated.

In one embodiment, the second ratings displayed in the second level menu respectively corresponding to the plurality of first ratings are same. In other embodiments, the second ratings displayed in the second level menu respectively corresponding to the plurality of first ratings are different.

Furthermore, the locking status comprise locking and unlocking.

Furthermore, after the selected second rating in the second level menu is locked, other second ratings in the second level menu higher than the selected second rating are automatically locked.

In the display method of parents lock function and the operation method thereof of the present invention, the program content rating and the corresponding age ratings are respectively displayed in two level menus; therefore, it is easy to be understood and does not make the users confused, and is more convenient for operation.

Other aspects and features of the present invention become apparent through the following detailed explanation referring to the drawings. But it should be aware that the drawings are only for the purposes of interpretation, rather than the scope limit of the invention which should refer to the attached claims. Also it should be aware that the drawings are only trying to illustrate the concept of the structures and processes described here, they are unnecessary to be accurately scaled unless otherwise indicated.

### DESCRIPTION OF THE DRAWINGS

FIG. 1 is a flowchart of a display method of parents lock function in accordance with an embodiment of the present invention.

FIG. 2 is a schematic diagram of the display method of FIG. 1.

FIG. 3 is a flowchart of an operation method of parents lock function in accordance with an embodiment of the present invention.

### DETAILED DESCRIPTION OF THE EMBODIMENTS

In order to make the above-mentioned objects, features and advantages of the present invention more obvious and easily understood, the following detailed description will be made combined with the accompanying drawings on the embodiments of the present invention.

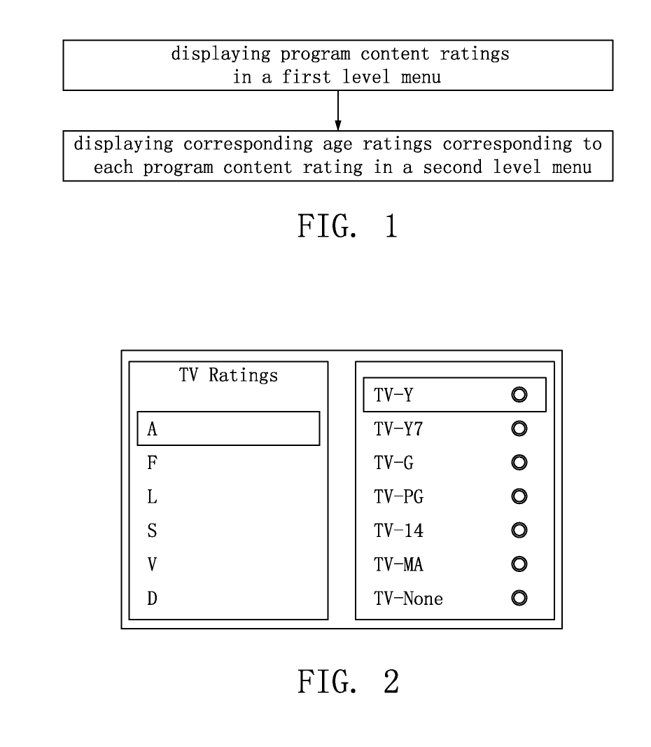

Please refer to FIGS. 1-2, wherein FIG. 1 illustrates a flowchart of a display method of parents lock function in accordance with an embodiment of the present invention, and FIG. 2 is a schematic diagram of the display method of FIG. 1. As shown in FIGS. 1-2, the display method of parents lock function disclosed in the embodiment, comprises: displaying program content ratings in a first level menu 110; respectively displaying age ratings corresponding to respective program content ratings in a second level menu 120.

Specifically, in the present embodiment, the program content ratings are mainly classified into A (average), F (Fantasy Violence), L (Adult Language), S (Sexual Situation), V (Violence) and D (Sexually Suggestive Dialog), wherein A represents ordinary TV programs, F represents TV programs having fantasy violence, L represents TV programs having strong coarse language, S represents TV programs having sex-related situation, V represents TV programs having violence, and D represents TV programs having strongly suggestive dialog. The age ratings are mainly classified into TV-Y, TV-Y7, TV-G, TV-PG, TV-14, TV-MA and TV-None, wherein TV-Y represents TV programs suitable for all ages of children, such TV programs are suitable for the children between 2 years to 6 years of age, and such TV programs should not be scared to young children; TV-Y7 represents TV programs suitable for children over 7 years of age, children of this age should have capabilities to distinguish the difference between real or acting, such television programs may include slight fantasy or comedic violence content, and may frighten children under 7 years of age, if violence or war scenes are more in this rating, it may also be subclassified into TV-F7-FV; TV-G represents TV programs suitable for all audience, guardians can be assured that minors watch such TV programs without any guidance since such TV programs should not contain the violence, coarse language dialog, no sex-related dialog or scene; TV-PG represents TV programs not suitable for teenagers and children to watch or viewable for minors accompanied with guardian, such TV programs may contain little violence, some sex-related scenes, indecent and coarse language or suggestive dialog and so on; TV-14 represents TV programs the general guardians do not want the children under the age of 14 to watch, such TV programs may contain intense violence, strongly sex-related situation, strong vulgar language, and strongly suggestive dialogue, etc.; TV-MA represents TV programs only suitable for adults and greatly unsuitable for minors under the age of 17 to watch, such programs may contain violent imagery, significantly sexual activity or brutal language, etc.; TV-None represents TV programs not required to be rated, and suitable for all audiences to watch.

In addition, in the present embodiment, each program content rating in the first level menu 110 corresponds to a second level menu 120, and the age ratings contained in the second level menus 120 can be same and comprise the above-mentioned TV-Y, TV-Y7, TV-G, TV-PG, TV-14, TV-MA and TV-None. Of course, the age ratings in the second level menus can also be different according to actual requirement, for example, in the second level menu corresponding to the program content rating V, the age ratings only contain TV-Y7, TV-PG, TV-14, TV-MA, and TV-None.

In the display method of parents lock function as shown in FIG. 1, the program content ratings are displayed in the first level menu, and the corresponding age ratings are displayed in the second level menu, therefore, it is easy to be understood and does not make the users confused, and is more convenient for operation.

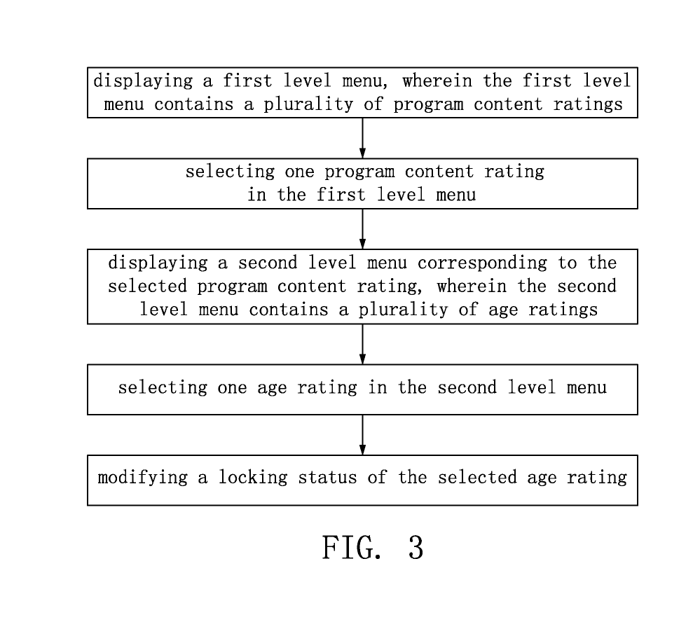

Please refer to FIG. 3, it is a flowchart of an operation method of parents lock function in accordance with an embodiment of the present invention. As shown in FIGS. 1-3, the operation method of parents lock function according to the embodiment comprises: displaying a first level menu 110, wherein the first level menu 110 contains a plurality of program content ratings; selecting one program content rating in the first level menu 110; displaying a second level menu 120 corresponding to the selected program content rating, wherein the second level menu 120 contains a plurality of age ratings; selecting one age rating in the second level menu 120; and modifying a locking status of the selected age rating (locked or unlocked).

Specifically, the user can move a cursor on the first level menu 110 and the second level menu 120 through the up and down keys of a remote controller, and then select one program content rating in the first level menu 110 or one age rating in the second level menu 120 through the enter button of the remote controller. The user can also modify the locking status of the selected age rating through the enter button of the remote controller; thereby the selected age rating is converted from a locked status into an unlocked status or from an unlocked status into a locked status. In addition, users can also take use of the left button of the remote controller (program-keys) to return the age ratings to the previous level menu, for example, return the second level menu, 120 to the first level menu 110.

Furthermore, in order to easily operate, when the user select a certain age rating in the second level menu 120 and lock it, all the age ratings higher than the selected age rating in the second level menu 120 would be locked. For example, when the age ratings in the second level menu 120 comprises TV-Y, TV-Y7, TV-G, TV-PG, TV-14 and TV-MA and the age rating of TV-G is locked, the age ratings of TV-PG, TV-14 and TV-MA higher than the age rating of TV-G are automatically locked. An operation of locking a certain age rating would not lock the age ratings lower than the selected age rating. An operation of unlocking a certain age rating would automatically unlock the age ratings lower than the selected age rating, but would not unlock the age ratings higher than the selected age rating.

In the present embodiment, the program content ratings are displayed in the first-level menu 110 and the age ratings are displayed in the second level menu 120. However, the skilled in the art can be understood that in other embodiments the age ratings can be displayed in the first level menu, while the program content ratings can be displayed in the second level menu.

In summary, in the display method of parents lock function and the operation method thereof of the present invention, the program content rating and the corresponding age ratings are respectively displayed in two level menus; therefore, it is easy to be understood and does not make the users confused, and is more convenient for operation.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

1. A display method based on a violence chip (Vchip), comprising:
displaying a plurality of first ratings in a first level menu; and
displaying a plurality of second ratings corresponding to each of the first ratings in a second level menu.

2. The display method based on a Vchip as claimed in claim 1, wherein the first ratings are program content ratings, and the second ratings are age ratings.

3. The display method based on a Vchip as claimed in claim 1, wherein the first ratings are age ratings, and the second ratings are program content ratings.

4. The display method based on a Vchip as claimed in claim 2, wherein the program content ratings comprises A, F, L, S, V and D, and wherein A represents ordinary TV programs, F represents TV programs having fantasy violence, L represents TV programs having strong coarse language, S represents TV programs having sex-related situation, V represents TV programs having violence, and D represents TV programs having strongly suggestive dialog.

5. The display method based on a Vchip as claimed in claim 2, wherein the age ratings comprises TV-Y, TV-Y7, TV-G, TV-PG, TV-14, TV-MA and TV-None, and wherein TV-Y represents TV programs suitable for all ages of children; TV-Y7 represents TV programs suitable for children over 7 years of age; TV-G represents TV programs suitable for all audience; TV-PG represents TV programs not suitable for teenagers and children to watch or viewable for minors accompanied with guardian; TV-14 represents TV programs the general guardians do not want the children under the age of 14 to watch; TV-MA represents TV programs only suitable for adults and greatly unsuitable for minors under the age of 17 to watch; TV-None represents TV programs not required to be rated.

6. The display method based on a Vchip as claimed in claim 1, wherein the second ratings displayed in the second level menu respectively corresponding to the plurality of first ratings are same.

7. The display method based on a Vchip as claimed in claim 1, wherein the second ratings displayed in the second level menu respectively corresponding to the plurality of first ratings are different.

8. An operation method based on a Vchip, comprises:
displaying a first level menu, wherein the first level menu contains a plurality of first ratings;
selecting one of the first rating in the first level menu;
displaying a second level menu corresponding to the selected first rating, wherein the second level menu contains a plurality of second ratings; and
modifying a locking status of the selected second rating.

9. The operation method based on a Vchip as claimed in claim 8, wherein the locking status comprise locking and unlocking.

10. The operation method based on a Vchip as claimed in claim 9, wherein after the selected second rating in the second level menu is locked, other second ratings in the second level menu higher than the selected second rating are automatically locked.

11. The operation method based on a Vchip as claimed in claim 8, wherein the first ratings are program content ratings, and the second ratings are age ratings.

12. The operation method based on a Vchip as claimed in claim 8, wherein the first ratings are age ratings, and the second ratings are program content ratings.

13. The operation method based on a Vchip as claimed in claim 11, wherein the program content ratings comprises A, F, L, S, V and D, and wherein A represents ordinary TV programs, F represents TV programs having fantasy violence, L represents TV programs having strong coarse language, S represents TV programs having sex-related situation, V represents TV programs having violence, and D represents TV programs having strongly suggestive dialog.

14. The operation method based on a Vchip as claimed in claim 11, wherein the age ratings comprises TV-Y, TV-Y7, TV-G, TV-PG, TV-14, TV-MA and TV-None, and wherein TV-Y represents TV programs suitable for all ages of children; TV-Y7 represents TV programs suitable for children over 7 years of age; TV-G represents TV programs suitable for all audience; TV-PG represents TV programs not suitable for teenagers and children to watch or viewable for minors accompanied with guardian; TV-14 represents TV programs the general guardians do not want the children under the age of 14 to watch; TV-MA represents TV programs only suitable for adults and greatly unsuitable for minors under the age of 17 to watch; TV-None represents TV programs not required to be rated.

15. The operation method based on a Vchip as claimed in claim 8, wherein the second ratings displayed in the second level menu respectively corresponding to the plurality of first ratings are same.

16. The operation method based on a Vchip as claimed in claim 8, wherein the second ratings displayed in the second level menu respectively corresponding to the plurality of first ratings are different.

17. The display method based on a Vchip as claimed in claim 3, wherein the program content ratings comprises A, F, L, S, V and D, and wherein A represents ordinary TV programs, F represents TV programs having fantasy violence, L represents TV programs having strong coarse language, S represents TV programs having sex-related situation, V represents TV programs having violence, and D represents TV programs having strongly suggestive dialog.

18. The display method based on a Vchip as claimed in claim 3, wherein the age ratings comprises TV-Y, TV-Y7, TV-G, TV-PG, TV-14, TV-MA and TV-None, and wherein TV-Y represents TV programs suitable for all ages of children; TV-Y7 represents TV programs suitable for children over 7 years of age; TV-G represents TV programs suitable for all audience; TV-PG represents TV programs not suitable for teenagers and children to watch or viewable for minors accompanied with guardian; TV-14 represents TV programs the general guardians do not want the children under the age of 14 to watch; TV-MA represents TV programs only suitable for adults and greatly unsuitable for minors under the age of 17 to watch; TV-None represents TV programs not required to be rated.

19. The operation method based on a Vchip as claimed in claim 12, wherein the program content ratings comprises A, F, L, S, V and D, and wherein A represents ordinary TV programs, F represents TV programs having fantasy violence, L represents TV programs having strong coarse language, S represents TV programs having sex-related situation, V represents TV programs having violence, and D represents TV programs having strongly suggestive dialog.

20. The operation method based on a Vchip as claimed in claim 12, wherein the age ratings comprises TV-Y, TV-Y7, TV-G, TV-PG, TV-14, TV-MA and TV-None, and wherein TV-Y represents TV programs suitable for all ages of children; TV-Y7 represents TV programs suitable for children over 7 years of age; TV-G represents TV programs suitable for all audience; TV-PG represents TV programs not suitable for teenagers and children to watch or viewable for minors accompanied with guardian; TV-14 represents TV programs the general guardians do not want the children under the age of 14 to watch; TV-MA represents TV programs only suitable for adults and greatly unsuitable for minors under the age of 17 to watch; TV-None represents TV programs not required to be rated.
